(19) United States
(12) Patent Application Publication
(10) Pub. No.: US 2013/0250348 A1
(43) Pub. Date: Sep. 26, 2013

(54) IMAGE PROCESSING APPARATUS, IMAGE PROCESSING METHOD, AND NON-TRANSITORY COMPUTER READABLE MEDIUM

(71) Applicant: Yoshikazu UGAI, Kanagawa (JP)

(72) Inventor: Yoshikazu UGAI, Kanagawa (JP)

(73) Assignee: FUJI XEROX CO., LTD., Tokyo (JP)

(21) Appl. No.: 13/594,057

(22) Filed: Aug. 24, 2012

(30) Foreign Application Priority Data
Mar. 22, 2012 (JP) 2012-065215

(51) Int. Cl. G06F 3/12

(52) U.S. Cl. 358/1.15

(57) ABSTRACT

An image processing apparatus includes a generating unit that generates, on image data that are obtained by scanning a document of a plurality of pages, multi-page format data in a single file, single-page format data in a page-by-page file, and association information that associates the multi-page format data with the single-page format data, and a transfer unit that transfers the multi-page format data, the single-page format data, and the association information to a server via a communication line in response to a transfer request of the image data.

### CROSS-REFERENCE TO RELATED APPLICATIONS

This application is based on and claims priority under 35 USC 119 from Japanese Patent Application No. 2012-065215 filed Mar. 22, 2012.

### BACKGROUND

(i) Technical Field

The present invention relates to an image processing apparatus, an image processing method, and a non-transitory computer readable medium.

(ii) Related Art

With advances in cloud computing, more and more users store, on a server on a cloud, image data including a variety of documents processed in offices.

### SUMMARY

According to an aspect of the invention, there is provided an image processing apparatus including a generating unit that generates, on image data that are obtained by scanning a document of a plurality of pages, multi-page format data in a single file, single-page format data in a page-by-page file, and association information that associates the multi-page format data with the single-page format data, and a transfer unit that transfers the multi-page format data, the single-page format data, and the association information to a server via a communication line in response to a transfer request of the image data.

### BRIEF DESCRIPTION OF THE DRAWINGS

Exemplary embodiment of the present invention will be described in detail based on the following figures, wherein:

FIG. 1 illustrates a basic configuration of a system of an exemplary embodiment of the present invention;

FIG. 2 is a functional block diagram of a multi-function apparatus;

FIG. 3 illustrates a concept of multi-page format data, single-page format data, and association information;

FIG. 4 is a flowchart illustrating a transfer process;

FIG. 5 diagrammatically illustrates the transfer process;

FIG. 6 illustrates an example of the association information;

FIG. 7 is a flowchart illustrating a preview process;

FIG. 8 diagrammatically illustrates the preview process;

FIG. 9 is a flowchart illustrating a printing process;

FIGS. 10A and 10B diagrammatically illustrate a first modification of the exemplary embodiment; and

FIGS. 11A and 11B diagrammatically illustrate a second modification of the exemplary embodiment.

### DETAILED DESCRIPTION

An exemplary embodiment of the present invention is described below with reference to the drawings.

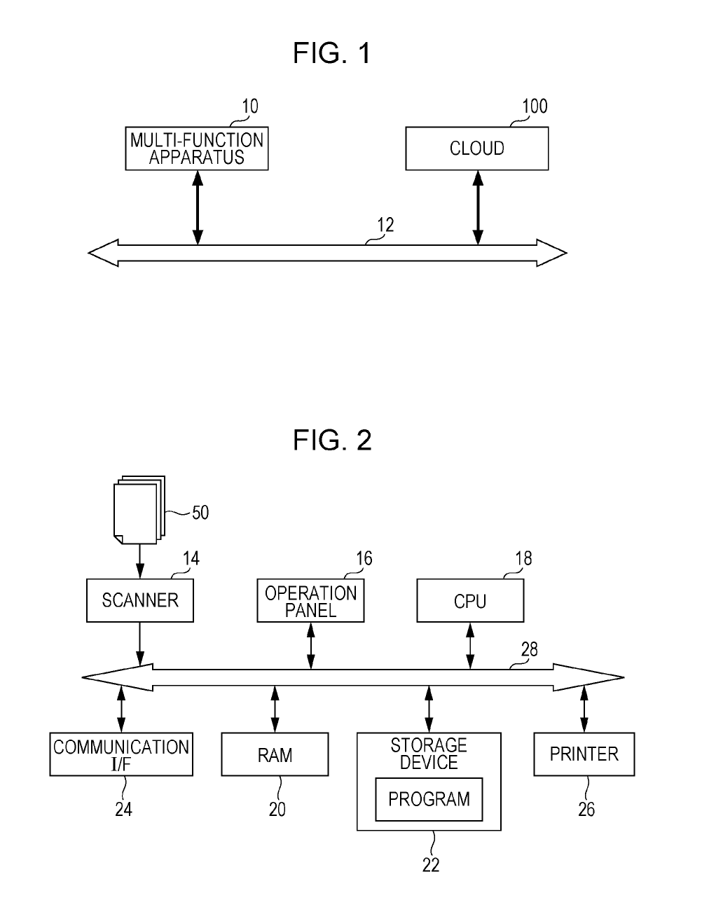

FIG. 1 illustrates a configuration of a system of the exemplary embodiment. A multi-function apparatus 10 serving as an image processing apparatus is connected to a cloud 100 via a communication line such as the Internet 12. The “cloud” in the exemplary embodiment refers to a group of computers present over the Internet, and particularly to a server computer present over the Internet.

The multi-function apparatus 10 has a variety of functions. For example, the functions of the multi-function apparatus 10 include a function of scanning a document, a function of transferring the scanned document to a document management server over the cloud 100 via the Internet 12, a function of downloading a document from the document management server over the cloud 100, and a function of previewing and/or printing a document. In accordance with the exemplary embodiment, the multi-function apparatus 10 scans a document to generate image data, transfers the image data to the document management server over the cloud 100 for storage, and creates preview images and/or prints image data stored on the document management server. Such processes of the multi-function apparatus 10 are described below.

FIG. 2 is a functional block diagram of the multi-function apparatus 10 serving as an image processing apparatus. The multi-function apparatus 10 includes scanner 14, operation panel 16, central processing unit (CPU) 18, random-access memory (RAM) 20, storage device 22, communication interface (I/F) 24, printer 26, and bus 28. The multi-function apparatus 10 includes the CPU 18, the RAM 20, and the storage device 22, and performs a variety of functions thereof by reading and executing a program stored on the storage device 22. The multi-function apparatus 10 is thus understood as a computer, particularly a client computer.

The scanner 14 scans a document 50 to obtain image data, and stores the obtained image data onto the RAM 20. Any format is acceptable for use in the image data, and may be a portable document format (PDF), for example.

When a user scans the document 50 with the scanner 14, the user sets a variety of parameters on the operation panel 16. The user also enters a variety of settings using the operation panel 16 when they transfer (upload) the scanned image data to the cloud 100. The user also enters a variety of settings using the operation panel 16 when they previews and/or prints a document stored on the cloud 100.

The storage device 22 stores a variety of processing programs and also stores a variety of image data downloaded from a document management server over the cloud 100.

The CPU 18 reads and executes a processing program stored on the storage device 22, thereby controlling elements of the multi-function apparatus 10 in accordance with the processing program. More specifically, the CPU 18 controls the scanner 14 to scan the document 50 in accordance with a parameter set via the operation panel 16, and then stores the resulting image data on the RAM 20. If the document 50 includes multiple pages, the CPU 18 forms the image data into a single file (generates multi-page format data) and the image data into a page-by-page file (generates single-page format data). The CPU 18 also generates association information that associates the multi-page format data with the single-page format data. The CPU 18 then stores the generated multi-page format data, single-page format data, and association information onto the RAM 20. In response to a request entered via the operation panel 16, the CPU 18 connects the multi-function apparatus 10 to the cloud 100 via the communication interface 24, and then transfers the multi-page format data, single-page format data, and association information generated and stored on the storage device 22 to the document management server over the cloud 100. In response to a request entered via the operation panel 16, the CPU 18 downloads image data stored on the document management server over the multi-function apparatus 10, causes the preview image data to be displayed on the operation panel 16 for previewing, and outputs the downloaded image data to the printer 26 for printing. The CPU 18 thus performs the generation process, the preview process, and the printing process on the multi-page format data, the single-page format data, and the association information. These processes are described below.

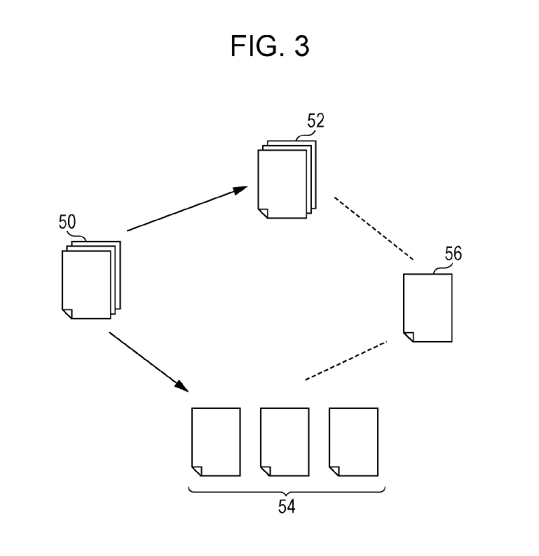

FIG. 3 illustrates a concept of the multi-page format data, the single-page format data, and the association information of the exemplary embodiment. The document 50 as a process target includes multiple pages, and is converted by the scanner 14 into digital data.

In a first operation, the CPU 18 processes the document 50 as a single file, and stores the document 50 onto the RAM 20. Data processed as a single file is multi-page format data 52. The multi-page format data 52 are tagged with a single file name. For example, the multi-page format data 52 may be “testdata.pdf” in PDF.

In a second operation, the CPU 18 processes each of the multiple pages of the document 50 as a single file, and then stores the files onto the RAM 20. Data processed as multiple page-by-page files are single-page format data 54. The single-page format data 54 are tagged with multiple file names. For example, if the document 50 includes four pages, the single-page format data 54 may be as below in PDF:

file “testdata-1.pdf,”

file “testdata-2.pdf,”

file “testdata-3.pdf,” and

file “testdata-4.pdf.”

The file “testdata-1.pdf” is a file of a first page of the document 50, and the file “testdata-2.pdf” is a file of a second page of the document 50. If the document 50 includes n pages (n is an integer equal to or larger than 2), the number of files forming the single-page format data 54 is also n files.

In a third operation, the CPU 18 generates association information 56 that associates the multi-page format data 52 with the single-page format data 54 and then stores the association information 56 onto the RAM 20. The association information 56 includes information that associates each page of the multi-page format data 52 with each file of the single-page format data 54. More specifically, the association information 56 identifies which page of the multi-page format data is associated with which file of the single-page format data 54. The association information 56 may further include storage locations and file names of the multi-page format data 52 and the single-page format data 54. The storage locations of the multi-page format data 52 and the single-page format data 54 refer to storage destination folders thereof in the document management server over the cloud 100. The storage destination folder may be the same folder or different folders. The storage location may be represented by a file path. In the document management server over the cloud 100 where a storage location is not directly specified, the association information 56 may include, instead of a storage destination of the document, information of a reference destination of the document. In the association information 56, each page of the multi-page format data 52 is associated with the respective file of the single-page format data 54. If a particular page of the multi-page format data 52 is specified, the file of the single-page format data 54 corresponding to the page is uniquely identified. The user may wish to preview a particular page of the multi-page format data 52, or may wish to print a particular page of the multi-page format data 52. In such a case, the particular page only may be previewed or printed by using the file of the single-page format data 54 corresponding to the particular page of the multi-page format data 52 instead of using the multi-page format data 52 directly. It is noted that downloading the multi-page format data 52 itself from the cloud 100 to the multi-function apparatus 10 is not necessary, and that downloading the corresponding file of the single-page format data 54 from the cloud 100 to the multi-function apparatus 10 is sufficient.

If the document 50 is a single page, the multi-page format data 52 and the single-page format data 54 become identical to each other. In such a case, the CPU 18 may still generate the single-page format data 54 separately from the multi-page format data 52. For example, the CPU 18 may generate a file “testdata.pdf” for the multi-page format data 52, and a file “testdata-1.pdf” for the single-page format data 54. Optionally, the CPU 18 may count the number of pages of the document 50 while the scanner 14 scans the document 50. If the number of pages is one, the CPU 18 does not generate the single-page format data 54 but generates only the multi-page format data 52.

The association information 56 associates the multi-page format data 52 with the single-page format data 54. As information related to the multi-page format data 52, the association information 56 may be understood as meta information. The association information 56 serving as the meta information may include a file name and a file path of the multi-page format data 52, and information identifying each file of the single-page format data 54 corresponding to each page of the multi-page format data 52. The association information 56 as the meta information may be present separate from original meta information of the multi-page format data 52. Alternatively, the association information 56 may be integrated with the original meta information of the multi-page format data 52 and may be present as part of the original meta information of the multi-page format data 52. The original meta information of the multi-page format data 52 may include attributes such as a date of generation of and an amount of the multi-page format data 52. When accessing the multi-page format data 52, the CPU 18 also accesses the association information 56 as the meta information. The CPU 18 thus learns not only the attribute of the multi-page format data 52, but also recognizes whether the single-page format data 54 is present together with the multi-page format data 52, and which page corresponds to which file if the single-page format data 54 is present together with the multi-page format data 52. In accordance with the exemplary embodiment, the association information 56 is generated as an entity separate from the original meta information of the multi-page format data 52. The present invention is not limited to this method.

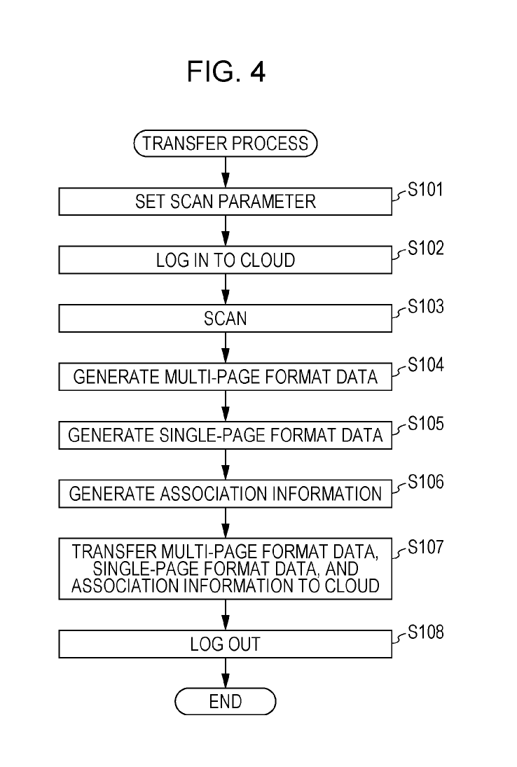

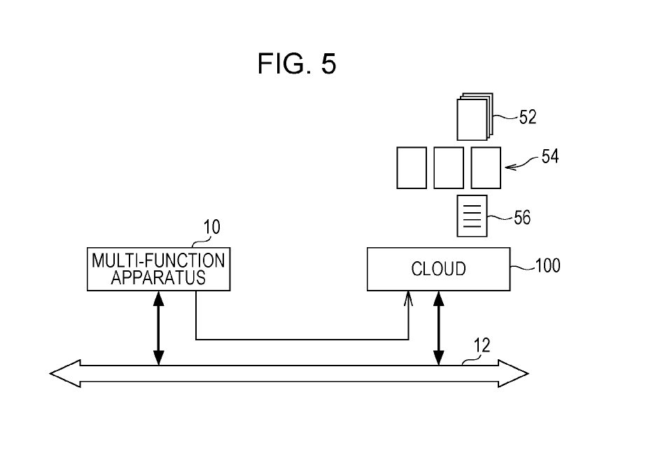

FIG. 4 is a flowchart illustrating a transfer process of the image data from the multi-function apparatus 10 of the exemplary embodiment to the document management server over the cloud 100. FIG. 5 diagrammatically illustrates the transfer process.

As illustrated in FIG. 4, the user inputs and sets parameters for scanning via the operation panel 16 of the multi-function apparatus 10 (S101). The parameters for scanning includes a color mode, resolution, file format, and the like. The user enters an ID and a password via the operation panel 16 of the multi-function apparatus 10, and logs in to the cloud 100 as a transfer destination (S102). The scanner 14 scans the document 50 in accordance with the set parameter (S103). The CPU 18 generates the multi-page format data 52 using the scanned data (S104). The CPU 18 also generates the single-page format data 54 using the scanned data (S105). The CPU 18 generates the association information 56 that associates the multi-page format data 52 with the single-page format data 54 (S106). The CPU 18 stores on the RAM 20 the generated multi-page format data 52, single-page format data 54, and association information 56.

Operations in S101 through S103 may be performed in any order. For example, the scan parameter may be set first, followed by the scanning of the document 50 and the login to the multi-function apparatus 10. The login to the cloud 100 is performed first, followed by the scan parameter setting and the scanning of the document 50. The user may be notified of the generation of the multi-page format data 52, but the user may not necessarily be notified of the generation of the single-page format data 54 and the association information 56. In other words, the CPU 18 may generate the single-page format data 54 and the association information 56 in a background process. The following is the reason for this. The user may be satisfied if the multi-page format data 52 are generated as a result of scanning the document 50. When the digital data of the document 50, after being transferred the cloud 100, are previewed and/or printed from the cloud 100, the single-page format data 54 and the association information 56 serve as an incidental data group that allows the user to preview and/or print the digital data of a particular page.

The CPU 18 transfers the generated multi-page format data 52, single-page format data 54, and association information 56 to the logged-in document management server over the cloud 100 (S107). After transferring the data, the CPU 18 logs out from the cloud 100 (S108), and ends the transfer operation.

Through the above process, the multi-page format data 52, the single-page format data 54, and the association information 56 are transferred from the multi-function apparatus 10 to the document management server over the cloud 100, and then stored on a specified folder on the document management server as illustrated in FIG. 5. As described above, the multi-page format data 52, the single-page format data 54, and the association information 56 may be stored on the same folder or on different folders. For example, the multi-page format data 52 may be stored on a folder specified by the user, and the single-page format data 54 and the association information 56 may be stored on a predetermined folder different from the folder specified by the user, such as a folder set by an administrator managing the multi-function apparatus 10. The multi-page format data 52 are to be recognized by the user who operates the multi-function apparatus 10, but there is no need for the user's recognition of the single-page format data 54 and the association information 56. The single-page format data 54 and the association information 56 may be stored on the document management server over the cloud 100, but may be treated as a “hidden file.”

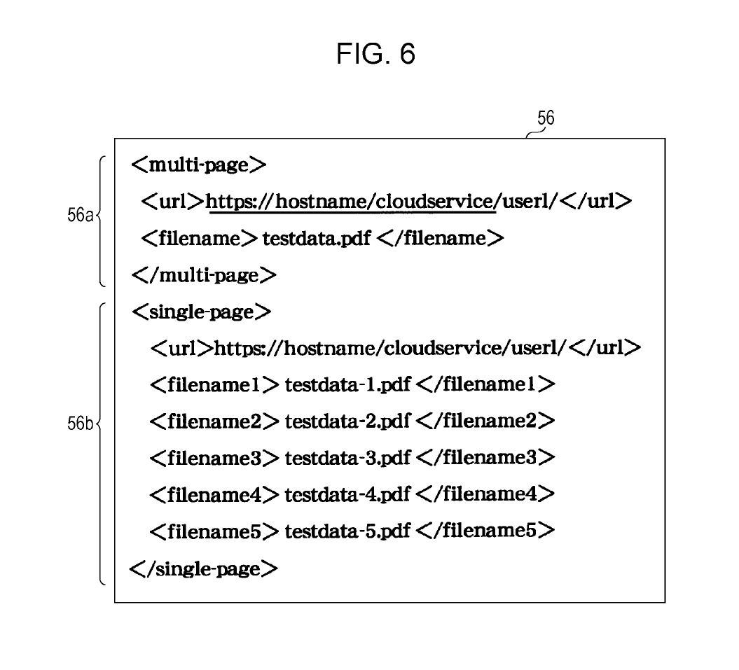

FIG. 6 illustrates an example of the association information 56. The association information 56 includes information 56a indicating a file name and a file path of the multi-page format data 52, and information 56b indicating a file name and a file path of the single-page format data 54 corresponding to the multi-page format data 52. In this example, the file name of the multi-page format data 52 is “testdata.pdf” and the file path is “https://hostname/cloudservice/user1” in URL format. The file names of the single-page format data 54 corresponding to the multi-page format data 52 are:

file “testdata-1.pdf,”

file “testdata-2.pdf,”

file “testdata-3.pdf,”

file “testdata-4.pdf,” and

file “testdata-5.pdf.”

The file path of the single-page format data 54 in URL is “https://hostname/cloudservice/user1.” By referencing the association information 56, the CPU 18 identifies the file name and the storage location of the multi-page format data 52, and the file name and the storage location of the single-page format data 54 corresponding to the multi-page format data 52. By referencing the file name of the single-page format data 54, the CPU 18 identifies which file corresponds to which page of the multi-page format data 52. For example, “testdata-1.pdf” corresponds to a first page of the multi-page format data 52, and “testdata-2.pdf” corresponds to a second page of the multi-page format data 52. In the example of FIG. 6, the file name of each file forming the single-page format data 54 serves as information that associates each page of the multi-page format data 52 with a respective file of the single-page format data 54. The association relation of the multi-page format data 52 and the single-page format data 54 may be identified using a listing format.

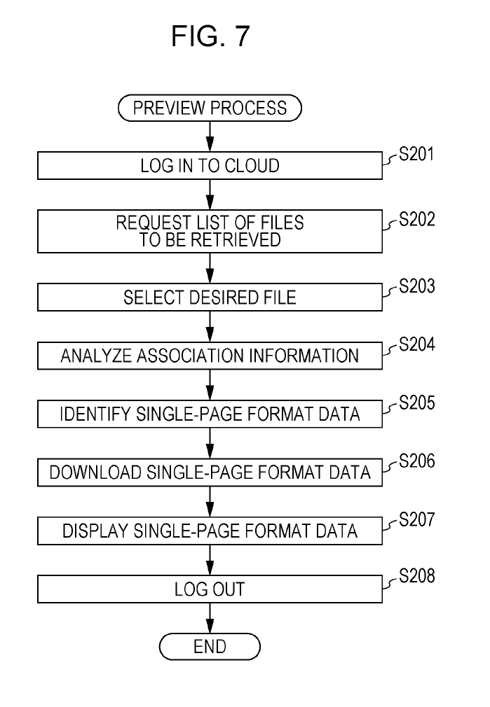

FIG. 7 is a flowchart illustrating a preview process performed at any timing subsequent to the transfer process. The user may log in to the document management server over the cloud 100 by operating the operation panel 16 (S201). The CPU 18 transfers via the communication interface 24 to the document management server a request for a list of files stored on the document management server over the cloud 100 (S202). In response to the request, the document management server over the cloud 100 transfers data of the files stored thereon to the CPU 18. The CPU 18 receives the data of the files via the communication interface 24, and displays the data of the files on the operation panel 16. If the single-page format data 54 and the association information 56 are treated as hidden files as described above, the multi-page format data 52 is displayed but the single-page format data 54 and the association information 56 are not displayed.

If the user selects a particular file from among the files displayed in the list (S203), the CPU 18 searches for the association information 56 of the selected file, and analyzes the association information 56 if the association information 56 is present (S204). If the association information 56 is included in the meta information of the multi-page format data 52, the association information 56 is searched for by simply accessing the meta information. If the association information 56 is present as an entity separate from the meta information of the multi-page format data 52, the CPU 18 searches the association information 56 with the file name of the multi-page format data 52 of the selected file as a search key. If the association information 56 is stored in the same folder as that of the multi-page format data 52, and has the same format as that of FIG. 6, the CPU 18 hits the association information 56 of FIG. 6 as the association information 56 having the file name of the multi-page format data 52 within the same folder as the multi-page format data 52 of the selected file. In the analysis of the association information 56, the file name and the file path of the single-page format data 54 corresponding to the multi-page format data 52 of the selected file are retrieved. Retrieved as the file names in the example of FIG. 6 are

file “testdata-1.pdf,”

file “testdata-2.pdf,”

file “testdata-3.pdf,”

file “testdata-4.pdf,” and

file “testdata-5.pdf.”

The retrieved file path in URL is “https://hostname/cloudservice/user1.” The CPU 18 identifies the single-page format data 54 corresponding to the multi-page format data 52 in this way (S205). If the user requests to preview a particular page of the selected file by operating the operation panel 16, the CPU 18 downloads from the document management server the file of the single-page format data 54 corresponding to the particular page and stores the file of the single-page format data 54 on the RAM 20 (S206). The CPU 18 reads the file from the RAM 20 and then displays the single-page format data 54 on the operation panel 16 (S207). If the user requests to preview another particular page, the CPU 18 downloads the file of the single-page format data 54 corresponding to the particular page and then displays the single-page format data 54 on the operation panel 16. The user may request to simply preview the selected file instead of previewing a particular page of the selected file. In such a case, the CPU 18 may download and display from the document management server the file of the single-page format data 54 corresponding to the first page. At any rate, the CPU 18 downloads the single-page format data 54 of a desired page instead of the multi-page format data 52 which are relatively higher in data amount than the single-page format data 54 of the desired page.

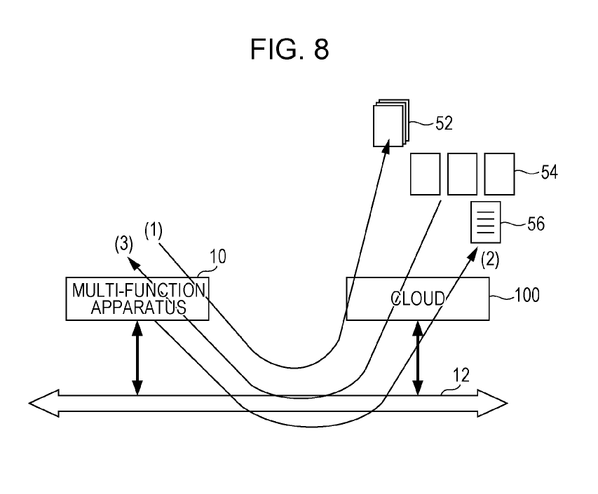

FIG. 8 diagrammatically illustrates a flow of the preview process. When the user requests to preview the multi-page format data 52 of the document 50 by operating the operation panel 16 (step (1) in FIG. 8), the CPU 18 accesses the association information 56 in the multi-page format data 52 of the document 50 and analyzes the content of the association information 56 (step (2) in FIG. 8). The CPU 18 identifies the single-page format data 54 corresponding to the multi-page format data 52 by analyzing the association information 56. The CPU 18 downloads only the file of the single-page format data 54 corresponding to a page specified by the user, and then displays the file of the single-page format data 54 on the operation panel 16. Without any knowledge of the single-page format data 54 and the association information 56, the user previews only the particular page of the multi-page format data 52. After previewing the desired page, the user logs out (S208).

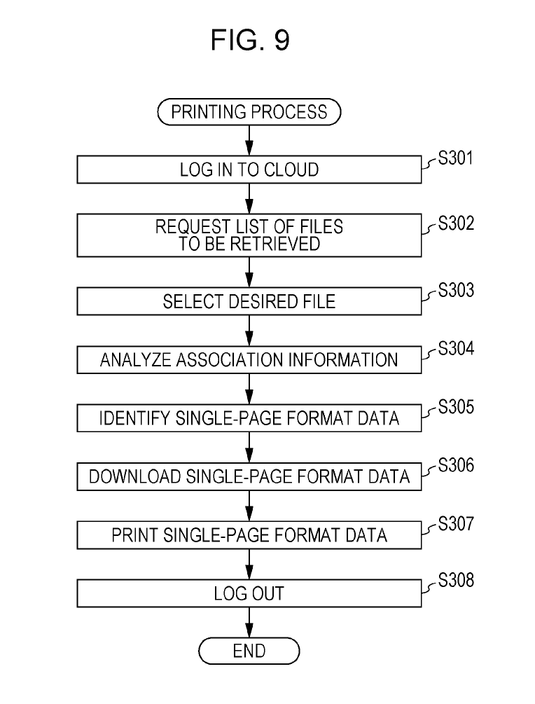

FIG. 9 is a flowchart illustrating a printing process performed at a timing subsequent to the transfer process. The user operates the operation panel 16 to log in to the document management server over the cloud 100 (S301). The CPU 18 requests the document management server over the cloud 100 via the communication interface 24 to transfer a list of files stored on the document management server (S302). In response to the request, the document management server over the cloud 100 transfers data of the files. The CPU 18 receives the data via the communication interface 24, and then displays the received data on the operation panel 16. As described above, if the single-page format data 54 and the association information 56 are treated as hidden files, the multi-page format data 52 are displayed but the single-page format data 54 and the association information 56 are not displayed.

If the user selects a particular file from among the list of files (S303), the CPU 18 searches for the association information 56 of the selected file, and analyzes the association information 56 if the association information 56 is present (S304). In the analysis of the association information 56, the file name and the file path of the single-page format data 54 corresponding to the multi-page format data 52 of the selected file are retrieved. Retrieved as the file names in the example of FIG. 6 are

file “testdata-1.pdf,”

file “testdata-2.pdf,”

file “testdata-3.pdf,”

file “testdata-4.pdf,” and

file “testdata-5.pdf.”

The retrieved file path in URL is “https://hostname/cloudservice/user1.” The CPU 18 identifies the single-page format data 54 corresponding to the multi-page format data 52 in this way (S305). If the user operates the operation panel 16 to request to print a particular page of the selected file, the CPU 18 downloads from the document management server the file of the single-page format data 54 corresponding to the particular page and stores the file of the single-page format data 54 on the RAM 20 (S306). The CPU 18 reads the file from the RAM 20 and then supplies the file to the printer 26 for printing (S307). If the user requests to print another particular page, the CPU 18 downloads the file of the single-page format data 54 corresponding to the particular page and then supplies the file of the single-page format data 54 to the printer 26.

The user may request to simply print the selected file instead of requesting to print a particular page of the selected file. In such a case, the CPU 18 may download the multi-page format data 52 and then supply the multi-page format data 52 to the printer 26 to print all pages. In other words, if the user requests to print a particular page of the selected file, the CPU 18 downloads only the file of the single-page format data 54. If the user requests to print the selected file only, the CPU 18 downloads the multi-page format data 52. In the printing operation of a particular page as well, the CPU 18 downloads the single-page format data 54 instead of the multi-page format data 52 which are relatively higher in data amount than the single-page format data 54. This arrangement reduces communication traffic between the multi-function apparatus 10 and the cloud 100, workload involved in the communication traffic, and a memory capacity used for the multi-function apparatus 10.

After the user previews the particular page of the file selected by the user, the user may request to print that particular page. The CPU 18 performs operations in S201 through S207 of FIG. 7. The CPU 18 then reads the single-page format data 54 of the page stored on the RAM 20 in response to the print request of the page, and then supplies the single-page format data 54 to the printer 26 for printing.

In accordance with the exemplary embodiment, the single-page format data 54 are generated separately from the multi-page format data 52 and are then stored on the document management server over the cloud 100. When a particular page of the document 50 is to be previewed and/or printed, the CPU 18 uses the single-page format data 54 rather than the multi-page format data 52. The user may preview and/or print the document 50 efficiently. The single-page format data 54 and the association information 56 are generated without a user intervention, and are processed and used in the background fashion. The user simply scans the document 50 with the scanner 14, transfers the scanned data to the document management server over the cloud 100, and then uses the operation panel 16 to instruct the desired document to be previewed and/or printed. The user is free from doing any particular additional operation.

In accordance with the exemplary embodiment, the CPU 18 in the multi-function apparatus 10 generates and stores the single-page format data 54 and the multi-page format data 52 over the cloud 100, and downloads the single-page format data 54 in accordance with the association information 56 in response to a preview/print request. No additional function is performed on the cloud 100. The exemplary embodiment is thus implemented using a general-purpose cloud 100.

The exemplary embodiment of the present invention has been described. The present invention is not limited to the exemplary embodiment. The exemplary embodiment may be implemented in a variety of modifications. These modifications are described below.

### First Modification

In accordance with the exemplary embodiment, the CPU 18 generates the multi-page format data 52, the single-page format data 54, and the association information 56 and then concurrently transfers these pieces of information to the document management server over the cloud 100. The CPU 18 may transfer one of these pieces of information at a separate timing, i.e., in an asynchronous fashion.

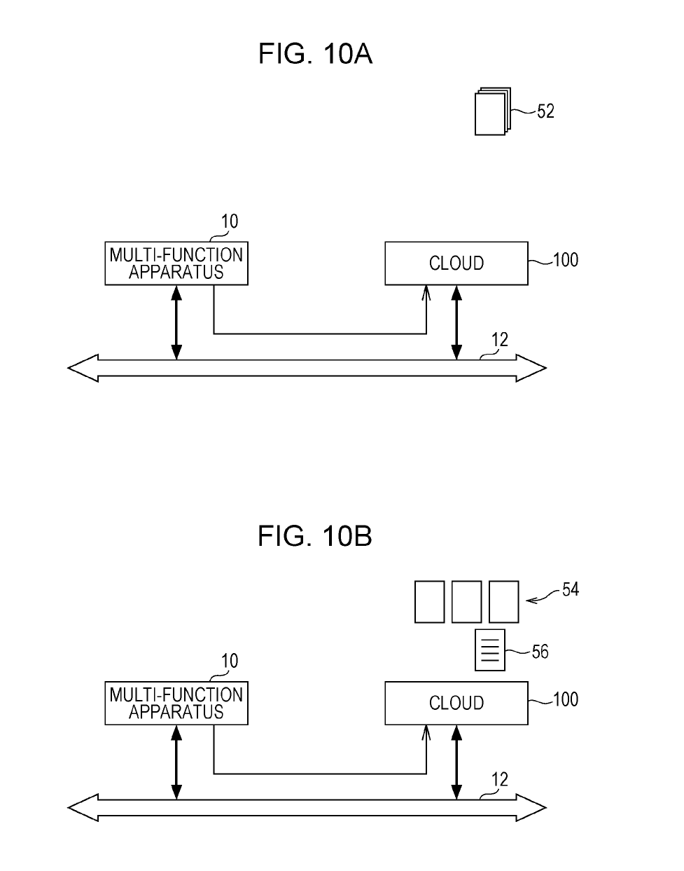

FIGS. 10A and 10B diagrammatically illustrate the transfer process of a first modification. As illustrated in FIG. 10A, the CPU 18 transfers only the multi-page format data 52 to the document management server over the cloud 100 at a timing immediately subsequent to the completion of the scanning of the document 50. As illustrated in FIG. 10B, the CPU 18 transfers the single-page format data 54 and the association information 56 to the document management server over the cloud 100 at any timing subsequent to the completion of the scanning of the document 50. When the single-page format data 54 and the association information 56 are transferred, all the data, i.e., a set of the multi-page format data 52, the single-page format data 54, and the association information 56 is prepared. If the communication traffic of the Internet 12 is relatively high, the multi-page format data 52 is transferred first. At any later timing when no communication traffic occurs, the CPU 18 may transfer the single-page format data 54 and the association information 56.

The timings of the data transfer may be listed as below:

(1) The multi-page format data 52 are transferred first, followed by the transfer of the association information 56 and then the transfer of the single-page format data 54.
(2) The multi-page format data 52 and the association information 56 are transferred first, finally followed by the transfer of the single-page format data 54.
(3) The multi-page format data 52 are transferred first, followed by the transfer of the association information 56, and then the transfer of the single-page format data 54.
(4) The multi-page format data 52 are transferred first, followed by the transfer of the single-page format data 54, and then the transfer of the association information 56.
(5) The single-page format data 54 are transferred first, followed by the transfer of the multi-page format data 52, and then the transfer of the association information 56.

The user may make a preview/print request of a particular page of the document 50 after the multi-page format data 52 are transferred to the document management server over the cloud 100 as illustrated in FIG. 10A but before the single-page format data 54 and the association information 56 are transferred to the document management server over the cloud 100 as illustrated in FIG. 10B. The CPU 18 searches the RAM 20, and identifies the single-page format data 54 if the corresponding association information 56 is stored on the document 50. The CPU 18 reads the single-page format data 54 from the RAM 20, and displays the single-page format data 54 on the operation panel 16 or supplies the single-page format data 54 to the printer 26. The user may thus preview and/or print the particular page without downloading the multi-page format data 52.

### Second Modification

In accordance with the exemplary embodiment, the CPU 18 generates the multi-page format data 52, the single-page format data 54, and the association information 56, and then concurrently transfers these pieces of information to the document management server over the cloud 100. In view of various conditions, the CPU 18 may respond to a user setting. More specifically, in response to the user setting, the CPU 18 may select between generating the multi-page format data 52 only and generating the multi-page format data 52, the single-page format data 54, and the association information 56 and may then transfer the generated information to the document management server over the cloud 100.

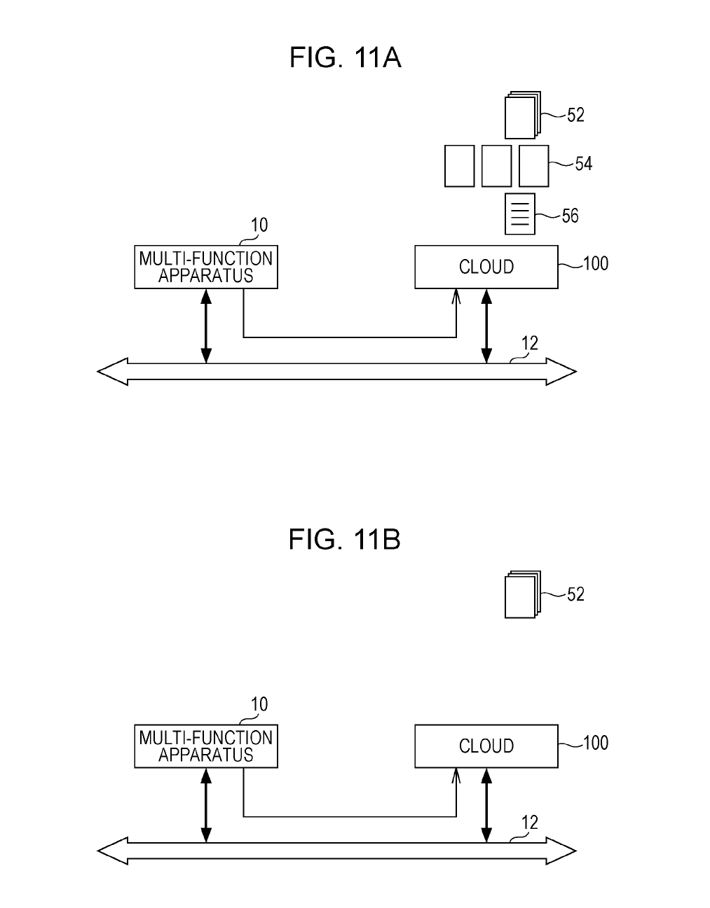

FIGS. 11A and 11B diagrammatically illustrate the transfer process of a second modification. The transfer process of FIG. 11A is performed in accordance with the user setting or the setting of the administrator managing the multi-function apparatus 10, or when a memory space is available in the storage capacity of the document management server over the cloud 100. In the same manner as described with reference to the modification described above, the CPU 18 generates the multi-page format data 52, the single-page format data 54, and the association information 56 and then transfers these pieces of information to the document management server over the cloud 100 concurrently or at different timings. The transfer process of FIG. 11B is performed in accordance with the user setting or the setting of the administrator managing the multi-function apparatus 10, or when no memory space is available in the storage capacity of the document management server over the cloud 100. The CPU 18 generates and transfers only the multi-page format data 52 even without generating the single-page format data 54 and the association information 56. If the user desires a preview/print of a particular page, the CPU 18 performs the transfer process of FIG. 11A. If the user does not desire a preview/print of the particular page, the CPU 18 performs the transfer process of FIG. 11B. The transfer process of FIG. 11A and the transfer process of FIG. 11B may be switched in accordance with the authority of the user. To verify the authority of the user, a user ID for login may be used. The switching between the transfer process of FIG. 11A and the transfer process of FIG. 11B may be performed on each document 50. For example, if the number of pages of the document 50 is one to three, the transfer process of FIG. 11B may be performed. If the number of pages of the document 50 is four or more, the transfer process of FIG. 11A may be performed. The switching between the transfer process of FIG. 11A and the transfer process of FIG. 11B in response to the number of pages may be manually set by the user, or automatically set by the CPU 18. In the switching, a user selection and a condition of the cloud 100 may be combined. For example, if no memory space is available in the memory of the document management server over the cloud 100 (with a transfer capacity subject to a limitation), the transfer process of FIG. 11B is performed. If a memory space is available in the memory of the document management server over the cloud 100 (with a transfer capacity subject to no limitation), the CPU 18 selects between the transfer process of FIG. 11A and the transfer process of FIG. 11B in response to the user selection and performs the selected transfer process.

The folder storing the single-page format data 54 and the association information 56 has been described. The single-page format data 54 and the association information 56 may be stored in the same folder as the folder of the multi-page format data 52, or in a folder different from the folder of the multi-page format data 52. The different folder is not necessarily a folder that the user recognizes. The different folder may be a folder that is managed by the administrator of the multi-function apparatus 10 or is set by a management company of the multi-function apparatus 10.

### Third Modification

If the user requests to delete the multi-page format data 52 using the operation panel 16 in accordance with the exemplary embodiment, the CPU 18 may delete not only the multi-page format data 52 stored on the document management server over the cloud 100 but also the single-page format data 54 and the association information 56 together.

### Fourth Embodiment

In accordance with the exemplary embodiment, the CPU 18 generates the multi-page format data 52, the single-page format data 54, and the association information 56 and then transfers these pieces of information to the document management server over the cloud 100. Optionally, the CPU 18 may generate an image with a size thereof reduced, in place of the single-page format data 54, and may then transfer the image.

### Fifth Embodiment

As described above, the association information 56 may be generated as part of the meta information of the multi-page format data 52, or may be generated as meta information different from the meta information of the multi-page format data 52 in the exemplary embodiment. Information that indicates the presence of an incidental file may be appended to the meta information of the multi-page format data 52, and the association information 56 may be constructed as the incidental file.

Only the multi-page format data 52 may be present or a set of the multi-page format data 52, the single-page format data 54, and the association information 56 may be present depending on the type of the document 50 or the type of the cloud 100. The data may be displayed in a manner that allows the user to recognize the contents of the data. More specifically, the file list retrieval is requested in S202 of FIG. 7 and the list of all files stored on the document management server over 100 is displayed on the operation panel 16. The CPU 18 uses two different icons of the file, one icon for only the multi-page format data 52, and the other icon for the set of the multi-page format data 52, and the single-page format data 54, and the association information 56. For example, if the set of the multi-page format data 52, and the single-page format data 54, and the association information 56 is used, the CPU 18 displays an icon that indicates the presence of multiple pages. For example, if the user selects the icon for only the multi-page format data 52, the CPU 18 downloads the multi-page format data 52. If the user selects the icon for the set of the multi-page format data 52, and the single-page format data 54, and the association information 56, the CPU 18 downloads the set of the multi-page format data 52, and the single-page format data 54, and the association information 56 and displays on the operation panel 16 a menu querying the user about which page to preview and/or print. When the user inputs and sets a particular page, the CPU 18 accesses the page of the single-page format data 54 and then downloads the page of the single-page format data 54.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a generating unit that generates, on image data that are obtained by scanning a document of a plurality of pages, multi-page format data in a single file, single-page format data in a page-by-page file, and association information that associates the multi-page format data with the single-page format data; and
a transfer unit that transfers the multi-page format data, the single-page format data, and the association information to a server via a communication line in response to a transfer request of the image data.

2. The image processing apparatus according to claim 1, further comprising:
a receiver unit that, in response to a preview request of a specific page of the image data, receives from the server a file corresponding to the specific page of the single-page format data associated with the multi-page format data in accordance with the association information stored on the server; and
a display that displays the received file.

3. The image processing apparatus according to claim 1, further comprising:
a receiver unit that, in response to a print request of a specific page of the image data, receives from the server a file corresponding to the specific page of the single-page format data associated with the multi-page format data in accordance with the association information stored on the server; and
a printer that prints the received file.

4. The image processing apparatus according to claim 1, wherein the transfer unit transfers at least one piece of the multi-page format data, the single-page format data, and the association information in an asynchronous fashion.

5. The image processing apparatus according to claim 1, wherein the association information specifies a name and a storage location of the multi-page format data, a name and a storage location of the single-page format data, and an association between each page of the multi-page format data and a respective file of the single-page format data.

6. The image processing apparatus according to claim 2, wherein the association information specifies a name and a storage location of the multi-page format data, a name and a storage location of the single-page format data, and an association between each page of the multi-page format data and a respective file of the single-page format data.

7. The image processing apparatus according to claim 3, wherein the association information specifies a name and a storage location of the multi-page format data, a name and a storage location of the single-page format data, and an association between each page of the multi-page format data and a respective file of the single-page format data.

8. The image processing apparatus according to claim 4, wherein the association information specifies a name and a storage location of the multi-page format data, a name and a storage location of the single-page format data, and an association between each page of the multi-page format data and a respective file of the single-page format data.

9. An image processing method comprising:
generating, on image data that are obtained by scanning a document of a plurality of pages, multi-page format data in a single file, single-page format data in a page-by-page file, and association information that associates the multi-page format data with the single-page format data; and
transferring the multi-page format data, the single-page format data, and the association information to a server via a communication line in response to a transfer request of the image data.

10. A computer readable medium storing a program causing a computer to execute a process for processing an image, the process comprising:
generating, on image data that are obtained by scanning a document of a plurality of pages, multi-page format data in a single file, single-page format data in a page-by-page file, and association information that associates the multi-page format data with the single-page format data; and
transferring the multi-page format data, the single-page format data, and the association information to a server via a communication line in response to a transfer request of the image data.
